(19) United States
(12) Patent Application Publication
(10) Pub. No.: US 2011/0043314 A1
(43) Pub. Date: Feb. 24, 2011

(54) Creative transformer

(76) Inventor: James Joseph Hogan, Lincroft, NJ (US)

Correspondence Address: BR. JAMES JOSEPH HOGAN;CHRISTIAN BROTHERS COMMUNITY, 854 NEWMAN SPRINGS ROAD, LINCROFT, NJ, 07738-1698, US

(21) Appl. No.: 11/891,220

(22) Filed: Aug. 10, 2007

(51) Int. Cl. H01F 17/00

(52) U.S. Cl. 336/178

(57) ABSTRACT

This invention disproves the conservation of energy in a core transformer as unavoidable. It shows that the design was a cause. Scientists, when they had a pair of equal forces (magnetomotive forces), allowed a pair of equal energies. This is changed by two innovations. One is called an “air-gap magnetic core”; it does not transfer all the force in the energy of a coil, to the core. And the other is a complete and radical change in circuitry.

There is a common primary magnetizer. And then there are two primaries and two secondaries. This is done to use two different air-gap magnetic cores instead of one and only and same core. One core makes the new energy and the other subtracts from that new energy. This differs radically from the traditional secondary which allows the primary to take in an opposing and neutralizing current and then makes you pay for it.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This concerns the conservation of energy in an electrical core transformer. This is studied in physics for which I have a Master of Science degree. In this I am not concerned with the magnetizing current and energy of the primary; I am concerned with the new energy created in the secondary and the corresponding loss of energy that happens in the primary as the result.

The traditional explanation, which forms my background, has not two energies directly confronting each other, but only the force part of the current and the force part of the volts. The current gives a force corresponding to the amps; the volts give a force proportional to the turns. Both the primary and secondary have a magnetomotive force

(amps×turns) that is not energy but is only the force part of energy. In mechanics, work or energy is force×distance. But only the force part is represented here. The magnetomotive forces of the primary oppose and equalize the other.

What is unusual here in electricity in contrast to mechanics is that this is like an army, instead of sending all the soldiers into a battle, sends only a fraction. Each side here, primary and secondary do the same. But what is like mechanics, is that indeed the opposing and equalizing forces are proportional to the energies, so to the scientists it looks like just a continuation of a conservation of energy, which they suppose is a law of nature. There is here 2 equal forces and 2 equal energies. Must 2 equal sets always be present? This demands an inquiry as to what in the first place relates energy to its force.

### BRIEF SUMMARY OF THE INVENTION

It took me 25 years of analizing and experimenting to solve this. Most of my experiments were at 20,000 cycles and done with high frequency cores, made of ferox.

This invention claims to make more output energy than input energy. And it makes the new energy from the original energy; no fuel from the outside is needed—no oil or gas. And no fumes to pollute the atmosphere and create global warming. It can be used anywhere electricity is used and even replace gas or oil. It originally is at high frequency but in time I expect lower frequencies to be used. And if necessary two high frequencies, rather close together, can be used to beat against each other and the beats will give a low frequency. So this invention can be used for homes, factories, transportation, communications and autos that will use no gasoline!

My investigation of the coexistance of energy and force leads to the electromagnet, since it has both. The coil has energy with force and that force is given to the magnetic core. Here is energy to force. The common practice is to give all of the force of the coil's energy to the core. It is then of no surprise, that 2 coils of equal energies have equal forces. Two electromagnets can both have energies of 10 and both have forces of 3. I make an innovation, called an “air gap magnetic core” in which that does NOT happen, because I put air gaps in the length of the magnetic core and all of the force from the coil does not all get to the core. And with 2 such cores I can have different size gaps, so that a 10:10 energy ratio can have a 7:3 force ratio. Or forces can be equal and the energies unequal—any kind of relationships!

Besides the radical change of the “air-gap magnetic core” I have another radical change. It comes from the consideration that there exists in the core transformer an energy gain (in the secondary) and a corresponding energy loss (in the primary). Usually both occur on the same core. My radical change is to give each operation its own separate core. And each core will be a different air gap magnetic core, with a different energy/force ratio. In the traditional with the one and only core, the gain and loss had the same ratio and so came out equal. Here, with different ratios, the gain and loss come out unequal.

In paragraph (0003) I asked the question whether when forces are equal the energies must also be equal. The answer is NO when there are different energy/force ratios in both the gained energy and the lost energy. Then the conservation of energy does NOT occur. Conservation occurs only, as in the traditional transformer, when the energy and force ratios are the same.

### BRIEF DESCRIPTION OF THE SEVERAL VIEWS OF THE DRAWINGS

FIG. 1 Undistributed and Distributed gap

FIG. 2 Measuring mmf with a tickler coil

FIG. 3 2 Cores of same force, different gaps & turns

FIG. 4 Like FIG. 3, but having same permeance

FIG. 5 Full circuit

### DETAILED DESCRIPTION OF THE INVENTION

This started by noticing that what regulated the energy transfer in the core transformer from primary to secondary, what is the parameter or “clerk of the works,” is NOT energy against energy, but magnetomotive force of secondary against the magnetomotive force of the primary. I will refer to this by just the word force. So now, in contrast to mechanics where it is energy vs. energy; it is force vs. force. This hit me like a bolt of lightning. I recognized something new going on. Nature shifted its gears.

The traditional scientist is complacent. It is easy to see why. He sees only what is the same as in mechanics; I see what is susprisingly different. And the traditionalist cites that while it is forces battling forces, there is also present an equality of the energies. So it happens, whatever the cause, that the energies come out equal as they do in mechanics. He thinks it must be a law of nature to so happen.

I say this demands further investigation. Must the equality of forces be always accompanied by an equality of energies. Common sense asks what is it that connects forces and energies. Is the connection one of nature or of the particular design being used?

The electromagnet is the only connection between energy and force. The energy and force in the coils wrapped around the magnetic core, give ALL of their force to the core. I notice that there are 2 unnecessary things being done here:

1) There is only one core being used by both the primary and secondary, instead of possibly a separate one for the primary and a different one for the secondary, and
2) Both the primary and the secondary coils give ALL of the force of the energy and force in the coil, to the core. I find a different way of doing things. And the conclusion will be that what has been happening is due, not to natural necessity but to the particular design. Not realizing it, the construction was making a set of equal energies coexist with a set of equal forces.

The basic requirement of nature in the traditional transformer is the equality of force; not the equality of energies!

My changes are more the work of an inventor than of the scientist. It was necessary to think “outside the box.” It is difficult for a scientist to be at ease with the deliberate loss of force. It seems to be wasteful, inefficient. It goes against his grain. Yet in a “tug of war” with the forces of the primary opposing those of the secondary, the loss of an opposing, an undesirable force that is in the way, produces action. That is how a vacuum cleaner works. We remove the air pressure above a carpet to let the air pressure below the carpet, act.

Now that you have been advised to expect what is closer to a revolution than an evolution, I explain the innovation called an “air gap magnetic core.”

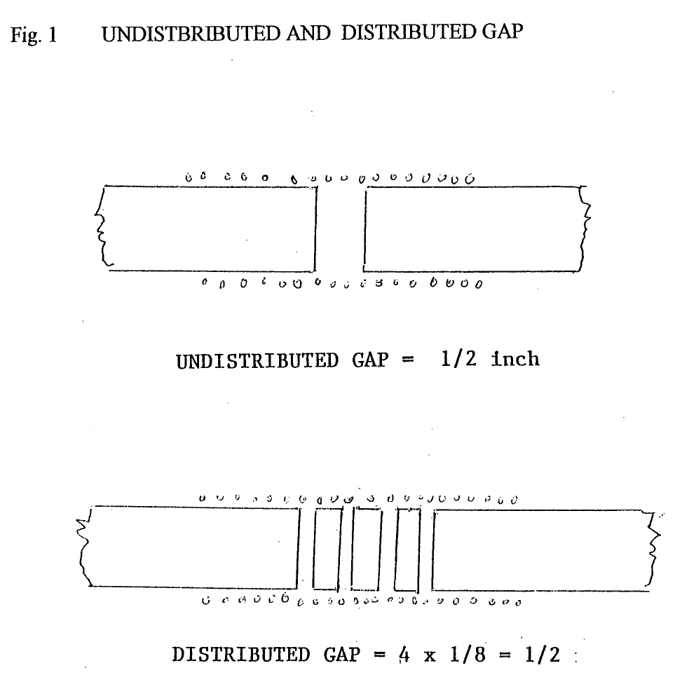

See p. 6 FIG. 1. It shows a magnetic core with a gap in the middle. Undistributed gaps could have a total made up of many smaller gaps; that, would cut down on fringing—flux leaping into air which is outside the cross-sectional area of the core. A good demonstration is to have a coil of the same width of a small gap; then place the coil above the gap and notice with a meter the induction into a secondary coil. Then move the coil above the solid core and notice the meter jump with more flux and induction.

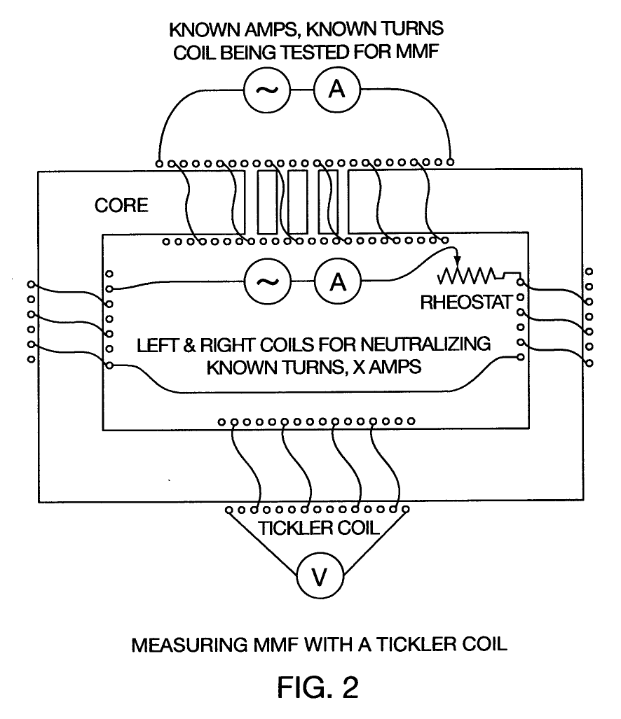

An accurate way of measuring the magnetomotive force can be seen in FIG. 2, p. 7. Between a tickler coil and the coil over a gap, is placed another winding. The current in the latter coil is increased until it reduces the tickler reading to zero.

The magnetomotive force, mmf, in an equation appears as F=amps×turns. With all of this not going from coil to core a new equation is needed. I call the force in the coil, F with max as a subscript. The force that is received by the core is F with rec as a subscript. I use k to give the fractional part transferred. So: F_{rec}=k Fₘₐₓ.

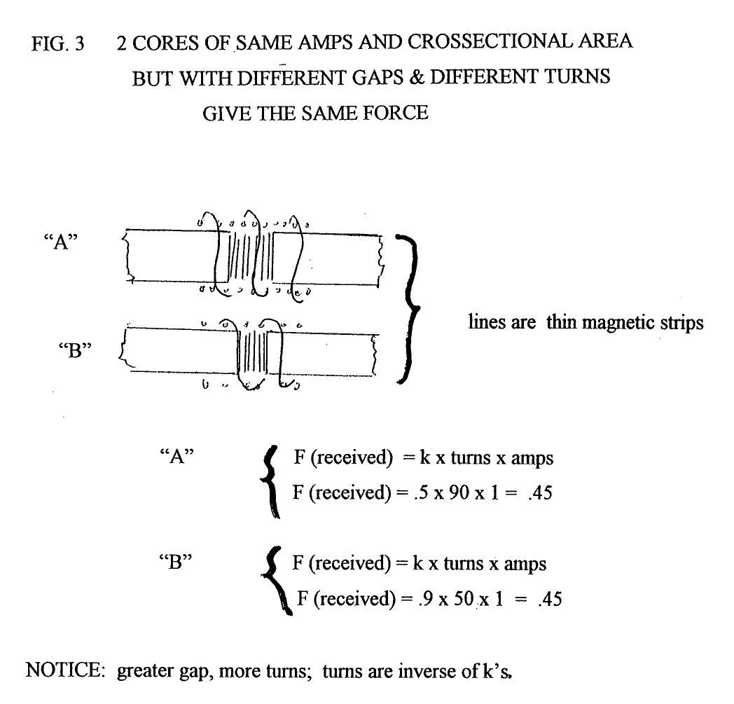

I wish to show how 2 cores with different gaps and different k′s, but each having different turns, can both have the same force. See FIG. 3, p. 8. More turns make up for the greater “k” loss. F_{rec}=k (amps×turns).

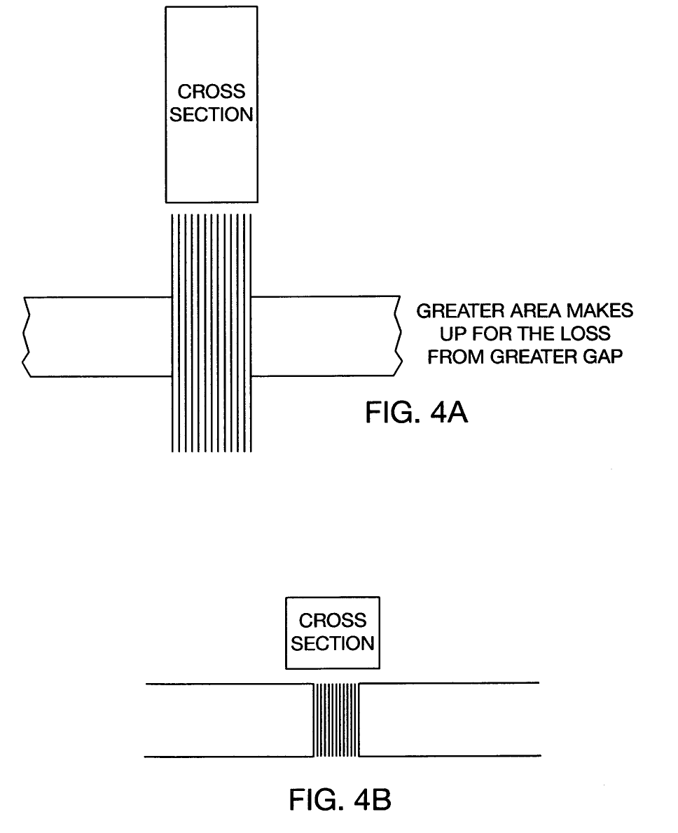

On p. 8, FIG. 3, the first core had a greater gap than the second, while each had the same cross-section. The bigger gap caused the first to have less permeability than the second. Now I will create a pair in which the first will have the same permeability as the second. I will make up for the wider gap in the first by having a greater cross section area so that the two can have the same permeability. See FIG. 4, p. 9. I now have 2 cores, both having the same forces and the same permeabilities. Note that the changed area does NOT change the force; force is determined by the length of the solid core affected by the coil.

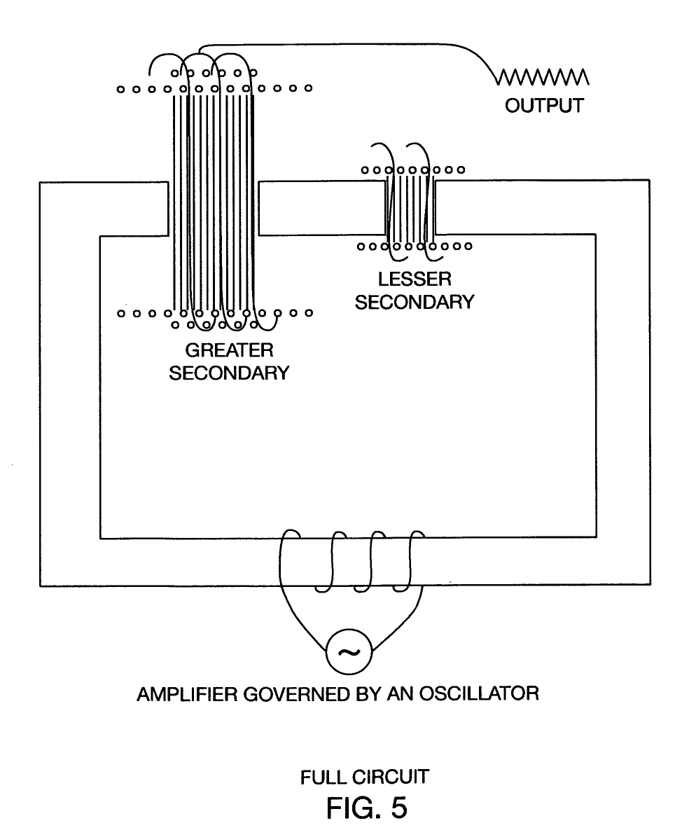

Now having discussed the big changes in the innovation “air-gap magnetic core” I proceed to the other innovation: a radically different transformer circuit. See FIG. 5, p. 10.

There is a kind of common primary to serve two other primaries. I called the common one a “magnetizing primary” and it will be in series with a “large gap primary” and a “small gap primary.” The two primaries are the ones pictured in FIG. 4, p. 9, having the one with k=0.5 and the other with k=0.9. The left core is surrounded by a greater turn secondary coil and the right core is surrounded by a lesser turn secondary coil.

Since both cores have the same permeability, both receive the same flux. So the left coil with more turns than the right, gets more voltage. The right coil, with the lesser voltage, is connected backwards (in reverse) with the left coil. The greater voltage dominates; a difference of the 2 voltages forms one current and the current goes in opposite directions on the cores. The forces are equal and opposite and there is no reaction on the common magnetizing core. And there is voltage output!

Because of the necessary air gap, the reluctance of a magnetic circuit is high. This is why high frequencies are used. If one wishes something more powerful, one can use a frequency 10 times greater. That makes both the volts and amps greater. So the power is the square of the increase of frequency.

I am planning to make and will make a model.

I could comment on action and reaction in a field. But this is not the place to make it. It has to wait for a technical physics journal.

Simple Conclusions:

1) In the traditional one-core transformer, nature demands an equality of force, not an equality of energy. Using the same core for both primary and secondary, makes the force to energy ratio the same for primary and secondary. Then the energies are equal and the conservation of energy occurs.
2) In the Creative Transformer, 2 secondaries are used, one for gained energy and one for lost energy. And each has a different force/energy ratio. Conservation does not have to occur.
3) Something astounding happens when an action (the flux of the induction) is in three dimensions; and the reaction (the magnetomotive force) is in only one dimension. I have never heard of this before! No wonder we have something new. This one vs. three dimensions is already in our traditional core transformer, but nobody seemed aware of it or took advantage of it. That is what I did and why it works.

The output, which is greater than the input in this invention, can be partly put back to the primary magnetizer to continue the operation endlessly.

1. What I claim as my invention is the production of more output electrical energy than input electrical energy, done by two innovations. The first innovation is called an “air-gap magnetic core” in which there are air spaces between the solid pieces of core; and the second innovation is the new circuitry in FIG. 5, p. 10. I don't know if the first innovation merits a patent; but I certainly think that the circuitry does merit a patent. So I claim the new circuitry as the reason for the patent. I am immediately assigning the ownership to La Salle Provincialate, Inc., which happens to be on the adjace t property. I trust it will delight in having another way of helping the poor.
